(19) United States
(12) Patent Application Publication
(10) Pub. No.: US 2006/0167873 A1
(43) Pub. Date: Jul. 27, 2006

(54) Editor for deriving regular expressions by example

(76) Inventors: Louis R. Degenaro, White Plains, NY (US); Judah M. Diament, Bergenfield, NJ (US); Jian Yin, Ossining, NY (US)

Correspondence Address: GEORGE A. WILLINGHAN, III;AUGUST LAW GROUP, LLC, P.O. BOX 19080, BALTIMORE, MD, 21281-9080, US

(21) Appl. No.: 11/040,514

(22) Filed: Jan. 21, 2005

(51) Int. Cl. G06F 17/30

(52) U.S. Cl. 707/6

(57) ABSTRACT

The present invention is directed to a method for deriving regular expressions by example, enabling users to author pattern matching and transformation logic without being regular expression experts. A user interface accepts an example string, tokenizes it, and enables designation of string recognition keys and classification of corresponding values. A suitable regular expression and transformation formula combination are produced according to user desires. The method supports more than one combination per example string, and a mechanism to specify and apply test cases.

### FIELD OF THE INVENTION

The present invention generally relates to information processing systems. More particularly, the present invention relates to methods and apparatus for deriving pattern matching expressions by example.

### BACKGROUND OF THE INVENTION

Pattern matching refers to the use of various program languages or utilities to search for strings or patterns in input data streams. In many applications, pattern matching involves the use of regular expressions. A regular expression provides a description of patterns composed from combinations of symbols and operators. In general, regular expressions provide a powerful system for recognizing strings in incoming data streams or incoming data requests. String recognition facilitates the application of desired processing to these incoming data requests. For example, a particular string or pattern within an incoming Hyper Text Transfer Protocol (HTTP) request can be used to indicate the identity of the user sending that request. This identity can be used to route the HTTP request to a server that is best suited to handle such requests from that user.

Unfortunately, reading and writing regular expressions is challenging or difficult even for experienced programmers. For non-programmers, understanding regular expressions is often next to impossible. Although techniques other than regular expressions, for example neural networks, genetic algorithms, Bayesian networks and Markov models, are also useful for recognizing patterns in data streams and incoming requests, these approaches also must be constructed by skilled programmers. In addition, these alternative approaches to pattern matching are predicated on machine learning rather than on user inputted parameters or definitions. Therefore, the use of regular expressions is preferred, and tools and systems have been developed to facilitate the use of regular expressions.

Conventional tools for engineering regular expressions require an understanding of a regular expression language. Examples of these types of editors are located at

http://www.larkware.com/RegexTools.html,

http://www.eclipseplugincentral.com/Web_Links+index-reg-viewlink-cid-126.html,

http://www.regexbuddy.com/create.html and

http://www.codeproject.com/vb/net/regexpservice.asp. Although these editors provide some degree of assistance in developing regular expressions, each one of these editors expects users to understand the syntax and semantics of regular expression languages.

U.S. patent application Publication No. US 2003/0158895 discloses a system for pluggable Uniform Resource Locator (URL) pattern matching for servlets and application servers. As disclosed, the simple hard-coded servlet container is replaced with a servlet container that allows for the plug-in of different request pattern-matching utilities. The effect is to modify the application server request interface to suit the particular needs of the developer. Although this allows for the incorporation of various matching schemes into a given request resolution, the programmer is required to implement pattern matching code according to a required standard mapping interface. The system disclosed does not provide support for authoring pattern matching logic, for example using a graphical user interface (GUI), or automated composition wizards arranged to help both programmers and non-programmers construct the desired pattern matching utility to be plugged-in. In addition, the described system lacks facilities to produce regular expressions, detrimentally requiring programmer authored pattern matching logic.

U.S. Pat. No. 4,550,436 is directed to parallel text matching methods in which a highly parallel matching circuit is provided to look at the entire lines of text simultaneously and in parallel for character matches. As disclosed, the system operates to compare input lines to a pattern in a parallel, simultaneous fashion, one symbol of the pattern at a time being compared to all of the symbols of the line. This use of parallel processing is directed to reducing the search time. Although the disclosed system and method can be used with regular expression operators, no assistance is given in the authoring or creation of regular expressions themselves.

U.S. Pat. No. 6,473,757 is directed to systems and methods for constraint-based sequential pattern mining. In particular, pattern mining techniques are disclosed that enable the incorporation of user-controlled focus in the mining process. Regular expressions are used to identify the family of sequential patterns of interest, and different relaxations of the regular expression constraints are used to prune the candidate patterns during the mining process. Again, no assistance or guidance is provided for the authoring of the underlying regular expressions. Therefore, knowledge of regular expressions and of parsing regular expressions is required for the authoring of the regular expressions to be used for pattern mining and for the management of these regular expressions to affect the desired pruning.

U.S. Pat. No. 6,496,835 is directed to methods for mapping data-fields from one data set to another in a data processing environment. If a field cannot be matched based on name alone, e.g. an identical match, rules are employed to determine a type for the field based on the field's name. The determined type of field is then used for matching. The rules are stated using regular expressions that list the text strings or substrings associated with a given field. For a given field, sets of rules, and therefore sets of regular expressions, are created. Although these rule sets automatically map one data set to a second data set and a graphical user interface (GUI) is provided for the end-user to alter the mapping results, the regular expressions themselves have to be programmed and stored in advance. The system does not provide a means for creating or modifying the regular expressions themselves, and in particular does not provide assistance to the end-user for authoring regular expressions.

U.S. Pat. No. 6,757,647 is directed to a method for encoding regular expressions in a lexicon. The disclosed method provides for creating electronically encoded lexicons that include regular expressions for augmenting the lexicon and computer-based language verification systems. Meta-characters are used to represent large sets of entries in the lexicon. Methods and support for generating regular expressions are not disclosed and no tools are provided to help lexicon authors.

A machine learning system is fed with a set of inputs and the corresponding outputs which are called training examples. Such a system is supposed to automatically generate an algorithm that produces the given outputs from the corresponding inputs. Problems with this approach include a machine learning system that takes a very long time to produce results and a machine learning system that requires a very large data set to produce a correct algorithm. In addition, supplying insufficient examples to a machine learning system may result in either the complete failure to generate an algorithm or the generation of an incorrect algorithm. Moreover, a machine learning system produced algorithm may not be efficient, easily understandable by humans or transformable into a regular expression.

Many could benefit from being able to utilize pattern matching schemes, but are unable or unwilling to learn the language of regular expressions. Therefore, a need exists for tools that will bring the power of regular expressions to such persons.

### SUMMARY OF THE INVENTION

The present invention is directed to methods and systems that provide for assisted authoring of data or pattern recognition statements in a user-friendly environment. Exemplary embodiments in accordance with the present invention use one or more examples of the desired patterns, strings and sub-strings as inputs. These inputs, or example patterns, are used to generate one or more pattern recognition statements. The generated pattern recognition statements are the output. Since actual examples of the desired patterns, strings or sub-strings are used to author the pattern recognition statements, systems and methods in accordance with the present invention can be viewed as using a “by example” paradigm to create the pattern recognition statements. Assistance is provided in producing the appropriate pattern recognition statements, since the pattern recognition statement output is generated from the user-provided input without the need for a prerequisite level of knowledge or understanding on the part of the user of the language in which the pattern recognition statements are written. Preferably, this language is a regular expression language.

Although the generated pattern recognition statement is fully functional and adequate to identify occurrences of the desired patterns, strings and sub-strings in an incoming request or stream of data, the present invention also provides for manual editing of the pattern recognition statement by the user. Editing by the user, however, is optional, and typically would only be accomplished by users that are well versed in the syntax and semantics of the language in which the pattern recognition statement is written.

In addition to generating pattern recognition statements, the present invention also facilitates transformations of patterns, strings and sub-strings that are recognized in an incoming request or data stream. After the pattern recognition statement is generated, incoming requests and monitored streams of data are tested using this pattern recognition statement. When the desired patterns are recognized, the recognized patterns are outputted. The form of the recognized pattern, however, may not be suitable or desirable for processing, routing or handling by subsequent systems. Therefore, the recognized pattern can be transformed, for example truncated, as desired. The desired transformation can also be associated with the generation of the pattern recognition statement so that transformation is automatically performed following pattern recognition. Alternatively, the transformation can be performed as a separate independent step, for example at the direction of the user.

Superior to machine learning systems, methods and systems in accordance with the present invention produce correct and efficient pattern recognition and transformation expressions, such as regular expressions, in a relatively short time using as few as one example pattern. Advantageously, the present invention can suggest a set of outputs and a corresponding regular expression for a user to select.

Exemplary systems and methods in accordance with the present invention preferably use a graphical user interface (GUI) to facilitate user interactions with the example pattern or string identification and with the pattern recognition statement creation. The GUI provides for user input of the example patterns, e.g. using a keyboard or mouse, and produces one or more files containing one or more pattern recognition and string transformation statements. Relevant information including the generated pattern recognition statement and any identified transformation is displayed within the GUI environment.

### BRIEF DESCRIPTION OF THE DRAWINGS

FIG. 1 is a flow chart illustrating an embodiment of a method for authoring pattern recognition statements in accordance with the present invention;

FIG. 2 is a chart illustrating an exemplary application of the method shown in FIG. 1;

FIG. 3 is a flow chart illustrating an embodiment of method for inputting additional classifications for use in the method of FIG. 1;

FIG. 4 is a representation of an embodiment of a graphical user interface in accordance with the present invention;

FIG. 5 is a flow chart illustrating an embodiment of a method for manually editing pattern recognition statements generated by the present invention; and

FIG. 6 is a flow chart illustrating an embodiment for managing and employing test cases and alerts for use with the present invention.

### DETAILED DESCRIPTION

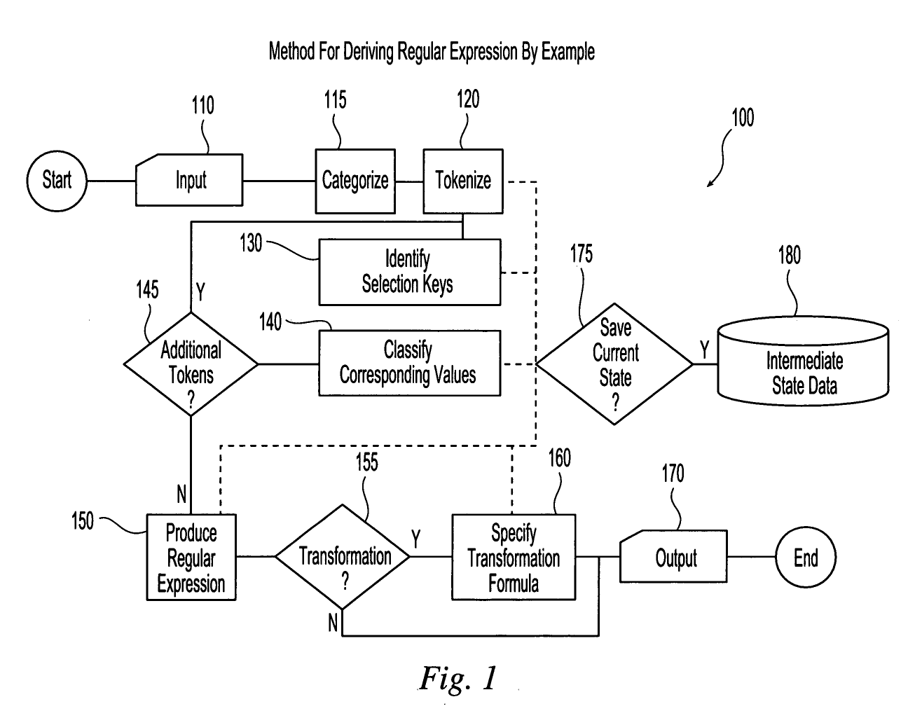

Referring initially to FIG. 1, an exemplary method for creating pattern recognition statements 100 in accordance with the present invention is illustrated. As illustrated, the method for creating pattern recognition statements utilizes a “by example” paradigm. In accordance with this type of creation paradigm, one or a plurality of examples of the types of patterns including complete patterns, strings or sub-strings to be found within an incoming request or data stream are used to generate pattern recognition statements that are capable of searching for these patterns, strings or sub-strings. As illustrated, the desired patterns, strings or substrings are identified and inputted 110. In one embodiment, the patterns, strings or substrings are inputted manually by the user. Alternatively, inputting can be accomplished automatically by downloading the desired patterns, strings or sub-strings from a database or by intercepting from a live feed in accordance with the type of requests or data streams to be monitored by the pattern recognition statement. By inputting the desired pattern, string or substring, the user specifies an example of the type of pattern or string to be recognized, classified and transformed in an incoming data request or stream of data.

Following input of one or more patterns, strings or substrings, each inputted example pattern is categorized 115, e.g. Hyper Text Transfer Protocol (HTTP) request or Internet Inter-ORB Protocol (IIOP) request. The categorization is related to the type of incoming request or data stream in which the inputted pattern, sting or sub-string is located and is used to parse the example pattern to generate tokens. Therefore, if incoming requests for a particular site on the World Wide Web are being analyzed, the category of pattern or strings is an HTTP, or HTTPS, request, because the system would be looking for incoming requests for one or more Websites. The category identifies a default, built-in or extension algorithm used to parse the example input.

In one embodiment, categorization includes input transformation from machine representation, e.g. binary data, to another format, such as one more suitable for human consumption, in preparation for the tokenization discussed below. This embodiment is particularly applicable in the case of an IIOP request as input.

Following categorization, each inputted example pattern, which includes complete or partial patterns, strings or sub-strings, is parsed, for example into tokens 120. This process is referred to as tokenizing. For a given example pattern at least one or two or more tokens are derived. In one embodiment, tokenizing is conducted in accordance with one or more extensions. Each token represents an example name and a corresponding value for string recognition.

All of the tokens for a given pattern, string or substring, do not have to be used. Therefore, following tokenizing, one or more tokens are identified to be used as a selection key 130 to be used to test incoming requests and data streams. Once a recognition or selection key is identified, the corresponding value for that selection key is classified 140. By classifying a given token or selection key, a partial pattern recognition statement, for example a partial regular expression, is created for that selection key. A determination is made about whether or not additional tokens, selection keys, are to be used 145. If an additional token is to be used as a selection key, then that token is identified 130 and a partial pattern recognition statement is generated for that token 140. This process is repeated iteratively, until all tokens to be used as selection keys are identified and the user is satisfied with the pattern, string or sub-string recognition criteria. In an alternative embodiment, in addition to selecting tokens for use as identification keys 130, tokens can be identified for removal as identification keys. This allows for editing of the recognition criteria.

After all of the desired tokens have been selected and classified, the result is a list or group of partial pattern recognition statements. This group of partial pattern recognition strings is used to create a complete pattern recognition statement that expresses the desired search criteria 150. If there is only one partial pattern recognition statement, then this single statement is used to create the complete data recognition statement. Alternatively, if there are a plurality of partial pattern recognition statements, all of the partial pattern recognition statements are used to create the complete pattern recognition statement. Any suitable language or syntax capable of searching or comparing strings of data or patterns within a data request or stream of data can be used to create the partial pattern recognition statements and complete pattern recognition statement. Preferably, a regular expression is used, and the generation of the complete pattern recognition statement produces a regular expression for recognizing strings of the example type according to the chosen recognition keys and classified values. The creation of the partial pattern recognition state and the complete pattern recognition statement does not require user understanding of the language used in either the partial or complete pattern recognition statement. The created compete pattern recognition statement can be outputted by the system to one or more users using any suitable user interface, for example a graphical user interface (GUI).

Since strings that are identified in an incoming data request or stream of data may not be of a desirable or suitable form, these strings can be modified or transformed. Therefore, a determination is made about whether or not a transformation is to be applied to recognized strings 155. If a transformation is to be performed, then the transformation formula is specified 160 and outputted 170 in association with the full pattern recognition statement. If a transformation is not to be applied, then the full pattern recognition statement alone is outputted 170.

In order to provide for the protection of data created during the process 100, and also to provide for the starting, stopping and re-starting of the creation of pattern recognition statements, the current state of each step in the process is regularly or continuously monitored to determined if the current state of that step, i.e. the information contained within that step should be saved 175. If a determination is made to save that information, then the information is saved persistently 180 in one or more databases. The saved information can be retrieved and restored at a later time for continued consideration. The determination to save the current contents of any step can be user initiated, initiated based upon a pre-determined time interval or initiated in response to a voluntary or involuntary interruption of the process.

Methods and systems in accordance with the present invention can produce pattern recognition statements such as regular expressions by composing a collection of partial pattern recognition statements, i.e. partial regular expressions, one for each token of the example input. If a given token resulting from the parsing of the inputted pattern, string or sub-string is not selected for inclusion as a selection key, then a partial pattern selection statement can be produced and associated with the token that indicates that the value of that token is not considered or not to be included in an analysis of the pattern recognition statement. For example, a “don't care” partial regular expression is produced for the tokens not selected by the user. A “match string” partial regular expression is produced for those tokens that are selected by the user. In addition an “assign to variable” partial regular expression is produced for the corresponding value, or portion thereof, for each selected token.

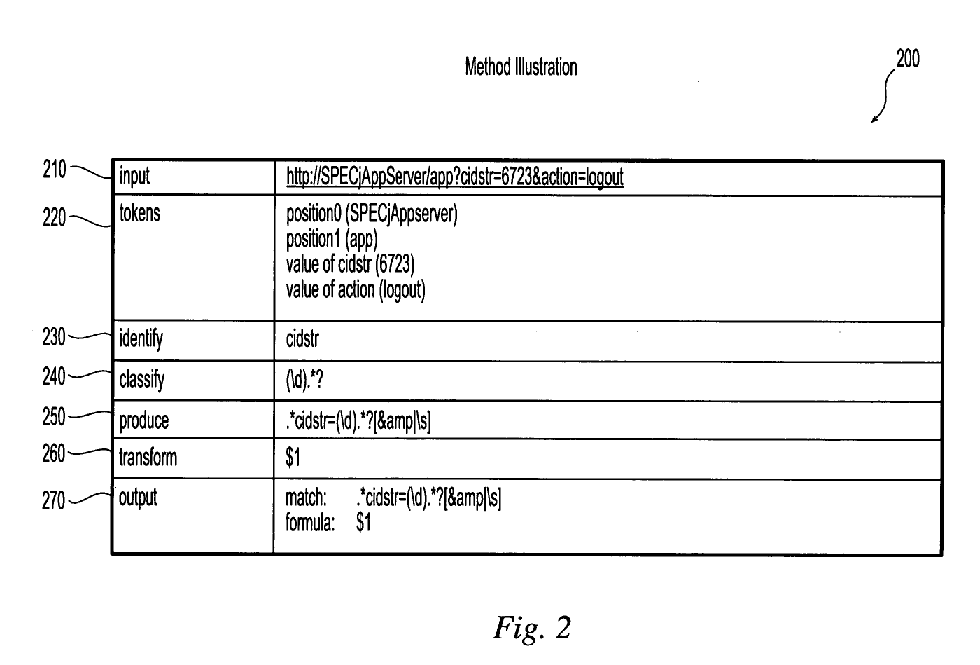

An exemplary embodiment of a method for creating a pattern recognition statement 200 in accordance with the present invention is illustrated in FIG. 2. As illustrated the inputs and outputs of the method, the tokens, classifications and transformations are shown. This exemplary embodiment is arranged for use in monitoring incoming HTTP requests for an identification of the destination to which the request is directed to permit proper routing or handling of that request. As illustrated, the user inputs a single example string 210, which as illustrated are the Uniform Resource Locator (URL) plus query string components of an HTTP request particular http://SPECjAppServer/app?cidstr=6723&action=logout. The input string is categorized as an HTTP string; therefore, an extension associated with HTTP strings is selected and activated for the purpose of tokenizing the inputted example string. Other types of input strings may also be tokenized, such as HTTPS, FTP, IIOP and myriad others, according to corresponding extensions. Alternatively, the method could be arranged to be specifically suited for the HTTP request strings. Such a customized application of this method would not require string categorization and extension activation. However, customized methods would be limited to application with a specific type of input string.

Having activated the appropriate extension, the input string is tokenized 220 in accordance with the tokenization rules defined in that extension. As illustrated, four tokens are created: position0, position1, value of cidstr, and value of action. Having created all of the tokens, the tokens to be used as identification selection keys are identified 230. As illustrated, a single token is selected, the value of cidstr. The corresponding value for this selected token is classified to be “first digit” 240, as expressed for example in regular expression syntax. Therefore, if the value of the token, i.e. the number associated with cidstr, is 100, then the classified value would be 1. Similarly, if the value of the token is 234, then the classified value of the token is 2. If the value of the token is 5678901234, then the classified value of the token is 5. Therefore, regardless of the length and alpha-numeric arrangement of cidstr, only the first digit is included in the classified value. In one embodiment, if no classification is identified, by default, the entire value of the token is presumed and used.

In order to facilitate classification selection by the user without requiring the user to understand or input the syntax associated with the classification, the user is preferably presented with a plurality of pre-defined classifications presented, for example, as an expandable palette of phrases to be used in performing the classification for each token. This expandable palette can be presented as a pull-down menu or pop-up box within a “Windows” type environment. Alternatively, presentation may be in the form of an input box that accepts user provided input text that uniquely identifies the desired phrase. Preferably, each phrase is presented to the user in common or plain language so as not to require an ability to read the prescribed syntax. Examples of phrases that can be included in the palette of phrases include, but are not limited to, “entire value”, “first_characters”, “last_characters”, “all characters following_”, “all characters preceding_”, “first digit”, “last digit” and combinations thereof. Some phrases may require user completion, for example entering the number of characters to be considered by the phrase. An example would be inputting a number into the phrase “first_characters” to achieve “first 5 characters”.

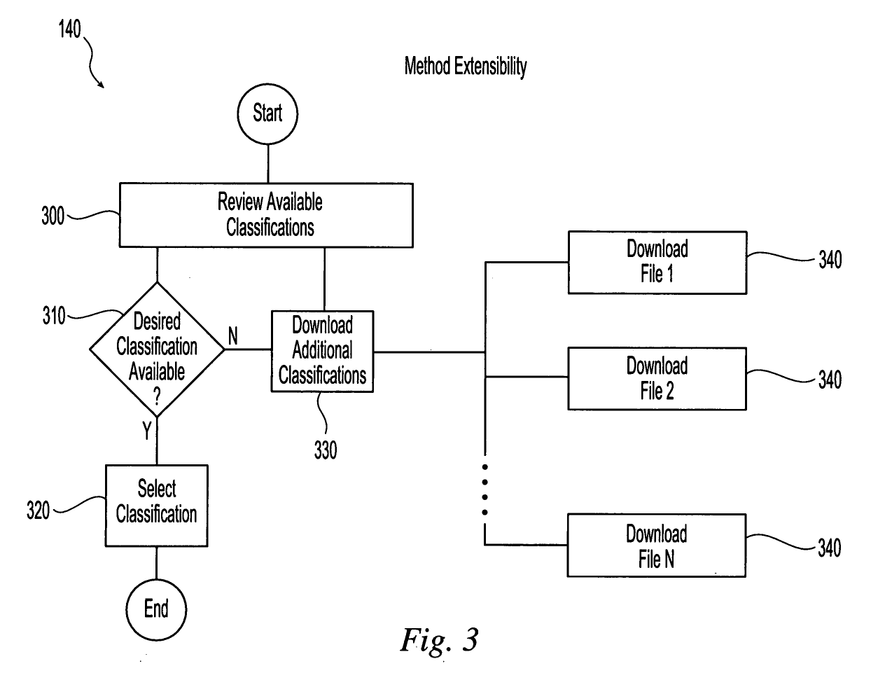

In one embodiment, the plurality of pre-defined classifications in the palette can be expanded by downloading additional classification files or types. Referring to FIG. 3, an embodiment of classifying corresponding values 140 is illustrated that provides for expansion of the classification palette. The classifications are reviewed 300, and a determination is made by the user about whether the desired or appropriate classification is available in the palette 310. If the desired classification is available, then that classification is selected 320. If the desired classification is not available, then one or more download files 340 containing classifications are identified and downloaded into the palette 330. Any suitable method for selecting and downloading files can be used. The files can be stored in one or more databases and accessed across a network including local and wide area networks. Having downloaded additional classifications, the classifications, including the original plurality of classifications and the downloaded additional classifications, are again reviewed 300 and the process repeated iteratively until the desired classifications are located and selected.

Although these download files are illustrated as providing classification lists, similar methods can be used to access additional extensions that are created and provided by programmers to extend any one of the capabilities of the method 100. For example, additional extensions can be provided that add one or more input categorizations and corresponding tokenization functionalities. In one embodiment, an extension is provided to add capabilities to categorize strings starting with “file://”. Other extensions can be provided that add token classification based upon file extension suffixes, such as “is picture” for suffixes “.jpg”, “.gif” and “.pdf”, and “is web page” for suffixes “.htm”, “.html” and “.xml”.

Referring again to FIG. 2, having identified and classified the desired token, the classification phrase is applied against the token to produce a partial pattern recognition statement 240, for example a partial regular expression, for the token's corresponding value. As illustrated in the present embodiment, the only selected token is the value of cidstr, which is classified according to user preference using the phrase “first digit”. This produces (\d).*? as the token's partial regular expression. As this was generated automatically in response to plain language classification phrases provided in a user-accessible palette, the user needed no knowledge of a regular expression language to produce the partial regular expression.

Having generated the partial pattern recognition statement, a complete pattern recognition statement 250, as illustrated a complete regular expression, for recognizing the desired strings is generated. As illustrated in the embodiment, the desired value of the parameter cidstr is its “first digit” and the complete regular expression is .*cidstr=(\d).*?[&amp|\s]. This complete regular expression is produced without additional input from the user and without a need for any level of understanding or knowledge of regular expressions on the part of the user.

The user decides if a transformation is going to be applied to any recognized strings. If a transformation is desired, the transformation formula for strings recognized by at least one of the complete pattern recognition statements is identified 260. As illustrated, the transformation formula $1 is identified as the first and only attribute recognized by the corresponding regular expression. That is, the transformation formula $1 produces the “first digit” of the value of cidstr. Therefore, the example string provided by the user 210 http://SPECjAppServer/app?cidstr=6723&action=logout is recognized by the regular expression 250 .*cidstr=(\d).*?[&amp|\s] and yields, via the transformation formula 260 $1, the string “6”. Since both a regular expression and transformation formula are selected, the complete regular expression and the corresponding transformation formula are outputted 270.

The user is not required to learn a language in order to produce transformation formulae. A transformation formula can be specified, for example, by choosing an ordering of the identified tokens 230, and optionally inserting plain text before or after one or more tokens.

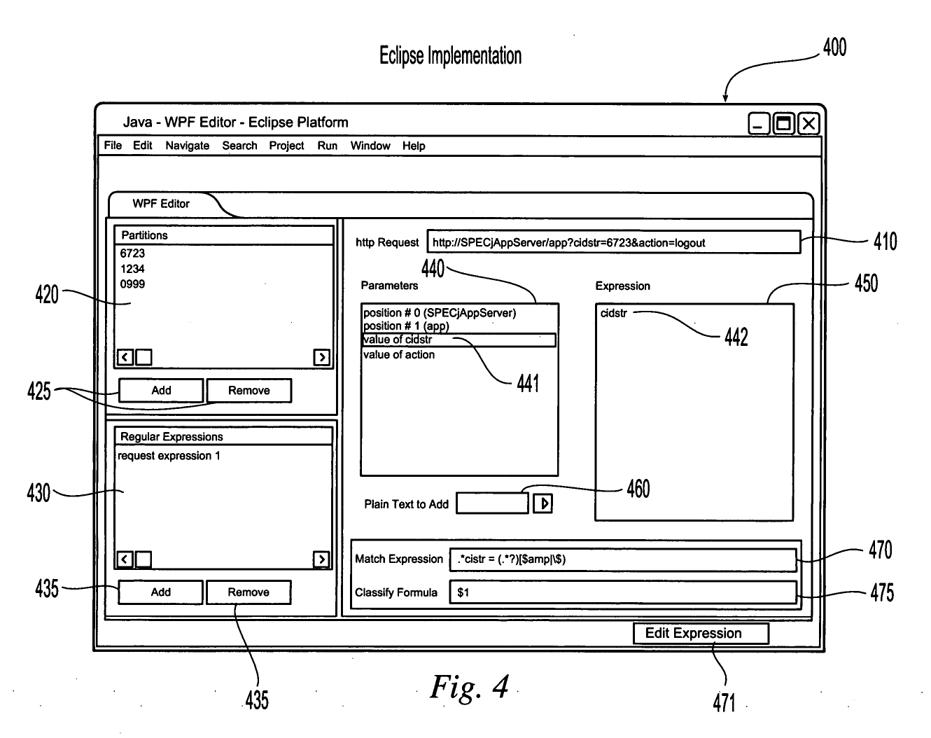

Referring now to FIG. 4, a graphical user interface (GUI) 400 for use in implementing methods in accordance with exemplary embodiment of the present invention is illustrated. As illustrated the GUI is an Eclipse (http://www.ecplise.org) plug-in implementation screen shot, although any suitable GUI can be used. The GUI 400 includes facilities and display areas for entry of the example inputs 410, partition management 420, 425, management of a regular expressions list 430, 435, selectable results of input string categorization and corresponding tokenization 440, results of user token selections 450 and management of individual regular expressions 470 and transformation formulae 475.

As illustrated, the GUI 400 is arranged to handle and process HTTP requests. The user enters at least one example pattern into the HTTP request window 410, and the method in accordance with a pre-defined extension associated with HTTP requests, auto-generates a parsed list of tokens that are displayed in the tokenization window 440. The desired tokens to be used as identification keys are highlighted from the token list and dragged into the token selection or expression window 450. Once the tokens are selected by clicking and dragging, the partial and full regular expressions are generated, and the complete regular expression is displayed in the match expression box 470. If desired, the complete regular expression can be edited by clicking into the expression box 470 and manually changing the expression. Once a complete regular expression has been generated, it can be named and saved for future use, and facilities are provided in the GUI 400 for the management of these regular expressions.

In one embodiment, the regular expressions list management facilities 430, 435 are used to add, delete, and select for modification. The currently selected expressions are displayed in the regular expression window 430. Selected buttons 435, for example ADD and REMOVE buttons, are provided to facilitate the addition of a new regular expression to, or the deletion of an existing regular expression from, the list of regular expressions 430. Each regular expression in the list 430 can be selected and each can be named according to user preference. Once an individual regular expression is selected, it can be modified using the other facilities, described below. A newly added regular expression that was not generated by an example input string is initialized having an empty string for example input.

The regular expression collection 430 can be ordered or prioritized according to user desires, so that each is applied to a given input request or input data stream in accordance with the pre-defined order until a string recognition occurs. In one embodiment, the regular expressions are ordered to look for more specific or more narrow recognitions first, placing these regular expressions at the top of the list, and then to look for more general recognitions by placing those regular expression near the bottom or end of the list.

In one embodiment, example input strings are provided by the user via a cut-and-paste operation. A uniform resource locator (URL) is copied from a web browser session and pasted it into the input window 410. Once this input example string is pasted, the associated extension categorizes and tokenizes the string accordingly. As illustrated, the user-provided example string is http://SPECjAppServer/app?cidstr=6723&action=logout, which is categorized as HTTP type and is thus tokenized according to an HTTP extension. The resulting tokenization is displayed 440 for user consideration.

The user selects individual displayed tokens to be utilized for both string recognition and string classification. In the example illustrated, the user has selected one token for use in string recognition and string classification—value of cidstr 441. In response to this action, the token cidstr 442 is placed in the expression window 450. The regular expression .*cidstr=(.*?)[&amp|\s] is generated and displayed in the match expression window 470. The transformation formula $1 is also generated and is displayed in the classify formula window 475. Specification of the transformation formula is accomplished through ordering of the tokens within the expression window 470. The user can change the ordering by right clicking on a token in the expression window 470 and choosing to “move up” or “move down” in the list. Doing so automatically changes the transformation formula 475 displayed and produced. In the embodiment shown 400, only one token has been identified, cidstr 442, and thus these ordering operations are not useful in this particular case. In addition, the user can pre- and post-pend or interweave additional text to the transformed string through use of the “Plain Text to Add” input area and submit arrow 460.

Management of lists of expected transformation results 420 is provide through the use of corresponding ADD and REMOVE buttons 425. As illustrated, three expected transformed strings are expected—6723, 1234 and 0999. This information can be used to prepare for or to validate the runtime results of utilizing the generated regular expressions and transformation formulae.

The regular expressions, transformations and expected results can be stored in any suitable format. Preferably, the persistent format used to store data representing the regular expressions, transformations, and expected results is an Extensible Markup Language (XML) file. These data can be partial or complete. An editing session can be initialized in the GUI 400 using previously saved data, and both completed and incomplete editing sessions can be saved to the XML file. In one embodiment, these operations are performed using the Eclipse “File->Open” and “File->Save” utilities, which is in an embodiment implemented by an Eclipse plug-in utilizing Eclipse Modeling Framework (EMF) modeling, as is well known in the related art. A completed file can be exported from Eclipse using the File-Export utility. In one preferred embodiment, the XML file produced conforms to that disclosed in co-pending and co-owned U.S. patent application Ser. No. 10/963,461, titled “Middleware For Externally Applied Partitioning Of Applications” and filed by Degenaro et. al. on Oct. 12, 2004. The entire disclosure of this application is incorporated herein by reference.

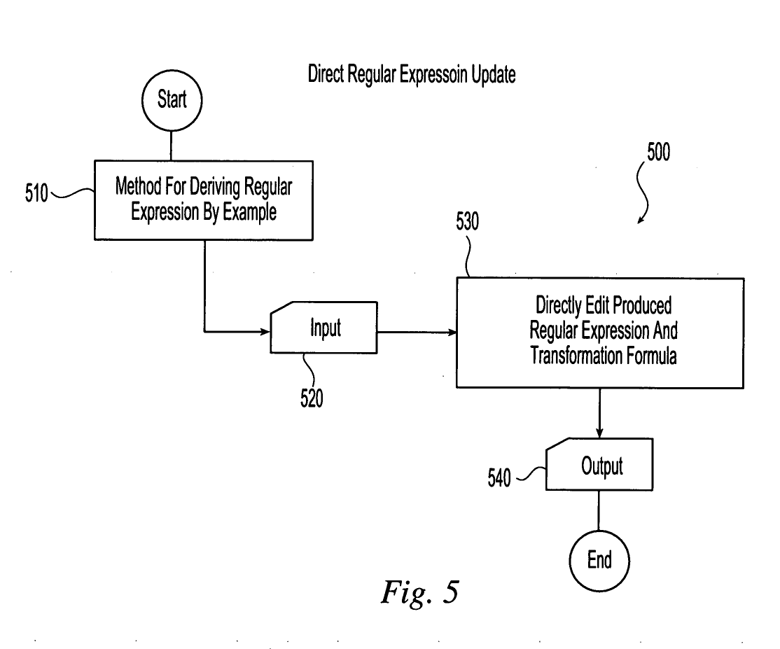

Referring to FIG. 5, an exemplary embodiment that provides direct regular expression editing capabilities 500 in accordance with the present invention is illustrated. In general, methods in accordance with the present invention including those illustrated for example in the GUI 400 of FIG. 4, can constrain the types of regular expressions that can be created and managed by adherence or fidelity to the ‘by example’ paradigm used to create the expressions. Although the expressions generated are adequate for locating and processing strings within incoming data requests and data streams, sophisticated users may wish to modify the regular expressions for purposes of experimentation or to tweak desired nuances in the regular expression to achieve a greater degree of precision. Therefore, manually editing of the generated regular expression is provided, for example with the GUI 400.

In one embodiment, a complete regular expression is generated 510 and is inputted 520 into a Direct Regular Expression Update process. The regular expression can be displayed in, for example, an editable box 470 (FIG. 4) within the GUI 400. Alternatively, manually editing can be selected using a button 471 in the GUI 400 that opens another interface (not shown) that provides for manual editing of the regular expression. Regardless of the interface provided, the user directly edits the string representations of regular expressions and transformation formulae 530, and the results are output 540 in the XML format prescribed by an EMF model, as described with referenced to FIG. 4 above.

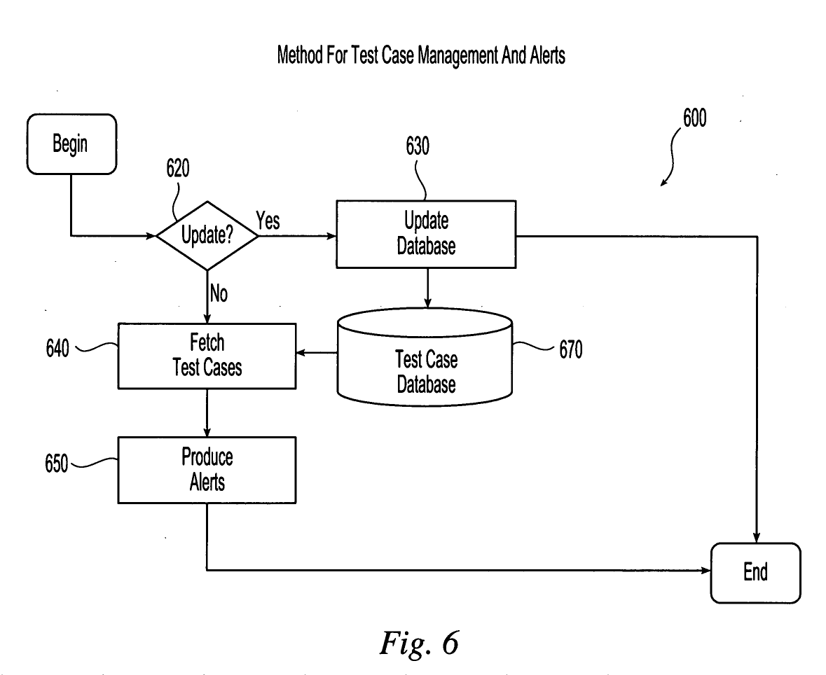

Referring now to FIG. 6, an embodiment for capturing test cases 600 corresponding to expected outcomes in combination with an alert mechanism is illustrated. The GUI 400 (FIG. 4) can be used to specify that an example string 410 and one or more corresponding partitions 420 are to be preserved as a test case. Therefore, in accordance with the present embodiment, an initial indication is made about whether or not to update, add, remove, modify, the test case database 620. If an update is to be made, the example string 410 and its corresponding partitions 420, which together comprise a test case, are updated 630, added to, deleted from, or modified in, as appropriate, in one or more databases 670. If an update is not to be performed, then the current set of test cases is retrieved 640 from the test case database 670. Each retrieved test case is applied to the current set of regular expressions and transformation formulae 430. Alerts are produced 650 for those test cases where the expected results differ from actual results by more than a pre-defined amount. For example, the actual results from a prioritized list of complete pattern recognition statements and any associated transformation formulae are compared to the expected results from the representative test cases. The present embodiment is useful to gain an understanding of how newly added, removed, modified, or re-ordered regular expressions and transformation formulae affect predecessors.

Once all test cases have been applied and all, if any, alerts have been produced, the process terminates. Alerts can be utilized by the interface 400 to make the user aware of unintended consequences of recent actions, e.g., adding a new regular expression or transformation formula, reordering existing regular expressions or transformation formulae, deleting an existing regular expression or transformation formula and combinations thereof.

The present invention is also directed to a computer readable medium containing a computer executable code that when read by a computer causes the computer to perform a method for deriving pattern matching expressions in accordance with the present invention utilizing a GUI in accordance with the present invention and to the computer executable code itself. The computer executable code can be stored on any suitable storage medium or database, including databases in communication with and accessible to the user or user equipment, and can be executed on any suitable hardware platform as are known and available in the art.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments, which would come within the spirit and scope of the present invention.

What is claimed is:

1. A method for authoring pattern recognition statements, the method comprising:
inputting at least one example pattern;
deriving at least one token from the inputted example pattern;
classifying a corresponding value of the derived token;
creating a partial pattern matching statement corresponding to the derived token and the classified corresponding value; and
creating a complete pattern recognition statement using the partial pattern recognition statement;
wherein the steps of creating the partial pattern recognition statement and creating the complete pattern recognition statement do not require user understanding of the language used in either the partial or complete pattern recognition statement.

2. The method of claim 1, wherein the step of creating the partial pattern matching statement comprises creating a partial regular expression and the step of creating a complete pattern recognition statement comprises creating a complete regular expression.

3. The method of claim 1, further comprising:
deriving a plurality of tokens from the inputted example pattern;
identifying one or more of the derived tokens;
classifying corresponding values for each one of the identified tokens;
creating a partial pattern matching statement corresponding to each identified token and the classified corresponding value; and
creating a complete pattern recognition statement using all of the partial pattern recognition statements.

4. The method of claim 1, further comprising:
categorizing the inputted example; and
deriving the at least one token based upon the categorization.

5. The method of claim 1, wherein the step of classifying a corresponding value of the derived token comprises selecting one classification from a plurality of pre-defined classifications.

6. The method of claim 5, further comprising:
reviewing all classifications in the plurality of pre-defined classifications;
downloading additional classifications; and
selecting the one classification from the plurality of pre-defined classifications and the downloaded additional classifications.

7. The method of claim 1, further comprising using a graphical user interface to facilitate inputting of the example pattern, deriving the token, creating the partial pattern recognition statement, creating the complete pattern recognition statement, displaying of the partial pattern recognition statement, displaying of the complete pattern recognition statement or combinations thereof.

8. The method of claim 7, wherein the graphical user interface further facilitates manual modification of the complete pattern recognition statement.

9. The method of claim 1, further comprising modifying the complete pattern recognition statement manually.

10. The method of claim 1, wherein the step of creating a complete pattern recognition statement comprising creating a plurality of complete pattern recognition statements, the method further comprising creating at least one formula to transform patterns recognized by at least one of the complete pattern recognition statements.

11. The method of claim 10, further comprising prioritizing the plurality of complete pattern recognition statements.

12. The method of claim 11, further comprising:
comparing actual results from the prioritized plurality of complete pattern recognition statements and corresponding transformation formulae to expected results from representative test cases; and
generating alerts on-demand for failing test cases.

13. A computer readable medium containing a computer executable code that when read by a computer causes the computer to perform a method for authoring pattern recognition statements, the method comprising:
inputting at least one example pattern;
deriving at least one token from the inputted example pattern;
classifying a corresponding value of the derived token;
creating a partial pattern matching statement corresponding to the derived token and the classified corresponding value; and
creating a complete pattern recognition statement based using the partial pattern recognition statement;
wherein the steps of creating the partial pattern recognition statement and creating the complete pattern recognition statement do not require user understanding of the language used in either the partial or complete pattern recognition statement.

14. The computer readable medium of claim 13, wherein the step of creating the partial pattern matching statement comprises creating a partial regular expression and the step of creating a complete pattern recognition statement comprises creating a complete regular expression.

15. The computer readable medium of claim 13, further comprising:
deriving a plurality of tokens from the inputted example pattern;
identifying one or more of the derived tokens;
classifying corresponding values for each one of the identified tokens;
creating a partial pattern matching statement corresponding to each identified token and the classified corresponding value; and
creating a complete pattern recognition statement using all of the partial pattern recognition statements.

16. The computer readable medium of claim 13, further comprising:
categorizing the inputted example; and
deriving the at least one token based upon the categorization.

17. The computer readable medium of claim 13, wherein the step of classifying a corresponding value of the derived token comprises selecting one classification from a plurality of pre-defined classifications.

18. The computer readable medium of claim 17, further comprising:
reviewing all classifications in the plurality of pre-defined classifications;
downloading additional classifications; and
selecting the one classification from the plurality of pre-defined classifications and the downloaded additional classifications.

19. The computer readable medium of claim 13, further comprising using a graphical user interface to facilitate inputting of the example pattern, deriving the token, creating the partial pattern recognition statement, creating the complete pattern recognition statement, displaying of the partial pattern recognition statement, displaying of the complete pattern recognition statement or combinations thereof.

20. The computer readable medium of claim 13, further comprising modifying the complete pattern recognition statement manually.
